(19) United States
(12) Patent Application Publication
(10) Pub. No.: US 2008/0134595 A1
(43) Pub. Date: Jun. 12, 2008

(54) REINFORCED MASONRY SILL AND THRESHOLD SEALANT BACKER

(75) Inventor: P. Michael Collins, Cincinnati, OH (US)

Correspondence Address: WOOD, HERRON & EVANS, LLP, 2700 CAREW TOWER, 441 VINE STREET, CINCINNATI, OH, 45202, US

(73) Assignee: PACC SYSTEMS I.P., LLC, Cincinnati, OH (US)

(21) Appl. No.: 11/609,370

(22) Filed: Dec. 12, 2006

(51) Int. Cl. E06B 1/70; E06B 1/04; E04G 21/14

(52) U.S. Cl. 52/204.5; 52/309.4; 52/214; 52/745.16; 52/741.41

(57) ABSTRACT

An apparatus for insertion between a masonry element at least partially defining a perimeter of an opening in an architectural structure and a frame surrounding the perimeter and having at least one surface includes a sponge structure adapted to rest against the frame and having at least one surface. The apparatus further includes a rigid member affixed to the sponge structure and adapted to rest against the masonry element and a coupling element affixed to the sponge structure and adapted to be coupled to a surface of the frame. In another aspect of this embodiment, the surface of the sponge structure is adapted to adhere to a sealant. The sponge structure may include closed cell blended EPDM neoprene.

### FIELD OF THE INVENTION

The invention generally relates to the formation of outer walls, window sills and door thresholds. More specifically, the invention relates to devices permanently installed to facilitate the formation of window sills and door thresholds and which provide decreased susceptibility of window and door frames to contraction and expansion of inner walls with respect to outer wall masonry elements in an architectural structure.

### BACKGROUND OF THE INVENTION

In the field of construction, windows and doors are commonly desirable. A window may include a window frame located in an opening through a wall, which communicates the exterior and interior portions of an architectural structure such as a residence. Similarly, a door may include a door frame communicating the exterior and interior portions of an architectural structure. A wall in a residence or other type of construction may have an inner, wooden frame wall spaced from an outer wall including masonry elements such as bricks or stucco. Such walls are often referred to as cavity walls. A window through an opening in such type of walls may include a horizontally-oriented window sill formed by an upper layer of bricks positioned immediately below a lower horizontal frame member of a window frame and may be canted downwardly for drainage and the like. Likewise, a door through an opening in such type of wall may include a masonry threshold.

Window and door frames take on a wide variety of configurations. They may, for example, include a lower horizontal frame member having a lower surface or a cavity or channel that must mate with the bricks forming the window sill or door threshold. Due to the difference in materials between, for example, an inner wood frame wall and an outer masonry wall including bricks, relative contraction and expansion of an inner wooden wall with respect to the window sill or door threshold formed of brick may occur, which may exert pressure on the window or door frame, thereby changing the frame's shape, size and position and potentially damaging or detrimentally affecting the operation and/or appearance of the window or door. Wood frame walls may, for example, contract as moisture evaporates therefrom while masonry walls may be relatively more stable.

During the construction of a masonry window sill or door threshold made, for example, of bricks, the mason inserts an upper layer of bricks in an initial horizontal orientation over an underlying layer of mortar. The outer forward edge of the bricks is then canted downwardly from the plane of a horizontal member of the window or door frame, thereby forcing the inner-wall-facing ends of the bricks to move upwardly into open areas of the lower horizontal frame member. If a brick along the sill or threshold is positioned such that it exerts an excessive force against the window or door frame, it may cause the frame to deform, thereby compromising the stability of the installation or the operation and/or appearance of the window or door. A challenge during installation of a window sill or door threshold lies in the lack of guidance a mason has when canting the bricks or similar masonry elements downwardly. It is difficult for the mason to provide a uniform angle for all bricks or other masonry elements along a window sill or door threshold if the installation is such that the inner-wall-facing ends of the bricks cannot touch the horizontal frame member of the window.

An apparatus to facilitate formation of masonry window sills and door thresholds would therefore be desirable. Similarly, an apparatus suitable to provide for the relative differences in contraction and expansion of inner and outer wall members made of different materials would be desirable. Finally, a method of forming a window sill offering the desirable characteristics described above would similarly be desirable.

### SUMMARY OF THE INVENTION

These and other problems in the prior art are addressed by this invention which, in one embodiment, includes an apparatus for insertion between a masonry element at least partially defining a perimeter of an opening in an architectural structure and a frame surrounding the perimeter and having at least one surface. The apparatus includes a sponge structure adapted to rest against the frame and having at least one surface, a rigid member affixed to the sponge structure and adapted to rest against the masonry element, and a coupling element affixed to the sponge structure and adapted to be coupled to a surface of the frame. In another aspect of this embodiment, the surface of the sponge structure is adapted to adhere to a sealant. The sponge structure may include closed cell blended EPDM neoprene.

In another embodiment, an apparatus for insertion between a masonry element at least partially defining an opening in an architectural structure and a frame having a channel, includes a compressible sponge structure having at least one surface and adapted to rest against the frame and a rigid member affixed to the sponge structure and adapted to rest against the masonry element. The sponge structure is adapted to be friction fit within the channel while the surface of the sponge structure is adapted to adhere to a flowable sealant.

In another embodiment, an architectural installation includes a frame having at least one surface and surrounding a perimeter of an opening of an architectural structure. The installation also includes a generally vertical inner wall, a generally vertical outer wall having at least one masonry element, and an apparatus positioned between the surface of the frame and the masonry element. In this embodiment, the apparatus includes at least one surface adapted to adhere to a sealant, a compressible sponge structure, and a rigid member affixed to the sponge structure and adapted to rest against the masonry element.

Advantageously, this invention permits formation of masonry window sills, door thresholds and the like without direct contact between the frame and the masonry elements, such that the frame is less susceptible to relative contraction and expansion of the inner wall in contact with the frame with respect to the masonry elements. Any expansion or contraction-related upward, downward or lateral movement of the inner wall with respect to the masonry elements is absorbed by a corresponding deformation and/or expansion of selected portions of the structural sponge component of the sealant backer assembly.

### BRIEF DESCRIPTION OF THE DRAWINGS

These and other objectives and advantages will become readily apparent to those of ordinary skill in the art from the following description of embodiments of the invention and from the drawings in which:

FIG. 1 is a perspective view of a sealant backer assembly according to one embodiment of this invention showing a structural sponge component, a hard backing element, an adhesive layer and a thin, releasable element;

FIG. 2 is an elevation cross-sectional view of the sealant backer assembly of FIG. 1;

FIG. 3 is a cross-sectional view showing an inner wall, an outer wall, a window frame, and a step in the formation of a masonry sill and the sealant backer assembly of FIGS. 1-2;

FIG. 4 is a cross-sectional view showing an inner wall, an outer wall, a window frame, and another step in the formation of a masonry sill and the sealant backer assembly of FIGS. 1-2;

FIG. 5 is a cross-sectional view showing an inner wall, an outer wall, a window frame, the sealant backer assembly of FIGS. 1-2 and a desired final orientation of a masonry element defining the window sill of FIGS. 3-4;

FIG. 6 is a detailed cross-sectional view of the encircled portion of FIG. 5.

FIG. 7 is a cross-sectional view showing an inner wall, an outer wall, a window frame, a masonry wall and a sealant backer assembly.

FIG. 7A is a detailed cross-sectional view of the encircled portion of FIG. 7

FIG. 8 is a partially disassembled perspective view of an alternative embodiment of a sealant backer assembly.

FIG. 9 is a cross-sectional view showing an inner wall, an outer wall, a window frame, a masonry sill and the sealant backer assembly of FIG. 8.

FIG. 9A is a detailed cross-sectional view of the encircled portion of FIG. 9.

### DETAILED DESCRIPTION

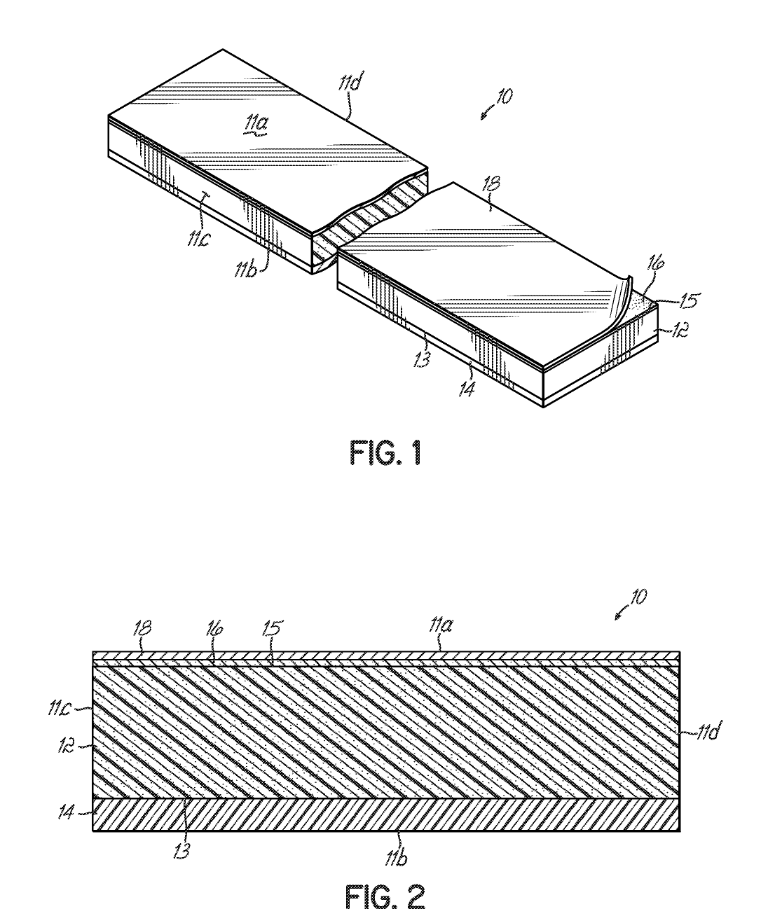

With reference to FIGS. 1-2, a sealant backer assembly 10 in one embodiment of this invention has a generally rectangular cross-sectional profile and includes a structural sponge component 12 occupying most of the volume defined by the sealant backer assembly 10, a rigid hard backing element 14, an adhesive element in the form of a thin layer 16 and a thin releasable element 18. The sealant backer assembly 10 is further defined by top and bottom faces 11a, 11b and lateral faces 11c, 11d.

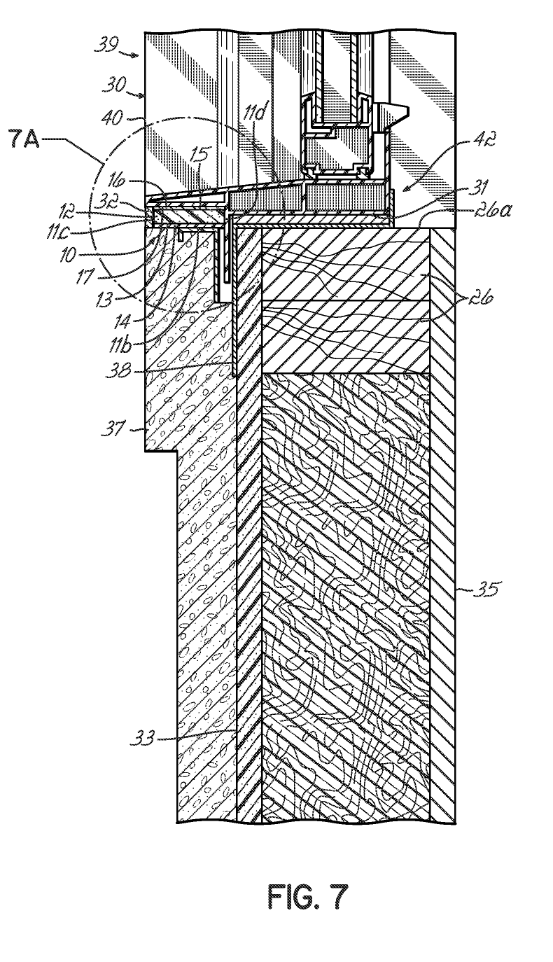

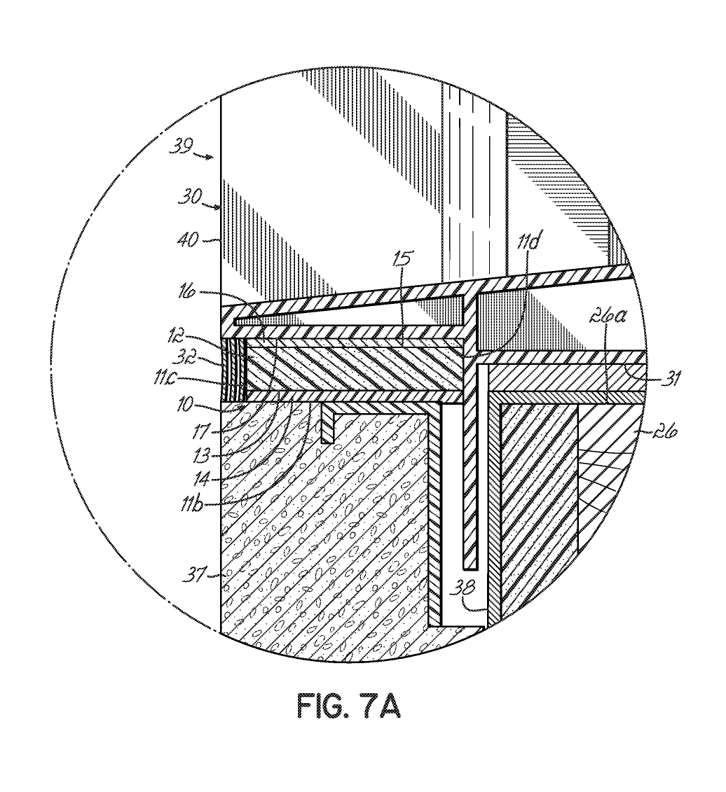

With reference to FIGS. 1-3, the structural sponge component 12 has opposed first and second faces 13, 15 and is made of a suitable material such that the component 12 can withstand a force exerted by an underlying row of masonry elements such as bricks 24. The length and width of the structural sponge component 12 is such that it can fit in a space between a window frame 30 and a row of masonry elements such as bricks 24 or stucco elements 37 (FIG. 7) defining a window sill or door threshold. The structural sponge component 12 may, for example, be of a length and a width substantially equal to those of a portion of a horizontal frame member 31 of the window frame 30 or door frame protruding from the plane of the exterior face 33 of an inner wooden frame wall 26. The structural sponge component 12 may be made, for example, of a material including closed cell blended EPDM neoprene.

The hard backing element 14 has a thickness substantially smaller than that of the structural sponge component 12 and is made of a rigid plastic resin material. While the hard backing element 14 is described as being made from a plastic resin, persons of ordinary skill in the art will appreciate that other materials may be substituted, so long as they are suitable to withstand the force applied by masonry elements such as bricks 24 or stucco elements 37 (FIG. 7) contacting the bottom surface of the hard backing element 14. In this embodiment, the hard backing element 14 has a length and a width that are substantially equal to those of the first face 13 of the structural sponge component 12 and is adhesively affixed to the first face 13 by any suitable methods or components, such as adhesive. Alternatively, other methods of affixing or adjoining these two surfaces may be substituted, so long as they are suitably chosen to maintain the required integrity of the interface between the structural sponge component 12 and the hard backing element 14. Alternatively, the hard backing element 14 may be integrally formed with at least a portion of the structural sponge component 12.

With continued reference to FIGS. 1-3, a coupling element in the form of a thin adhesive layer 16 substantially covers the second face 15 of the structural sponge component 12. The adhesive layer 16 is made of a suitable material such that it can bond or be at least partially integrally formed with the second face 15 of the structural sponge component 12. The adhesive layer 16 may include a pressure-sensitive adhesive, so long as it is also suitable to bond to the protruding portion of the bottom surface 17 of the horizontal frame member 31 of the window frame 30 or door frame. Alternatively, a different type of coupling element may be substituted for the adhesive layer 16, so long as it is suitably coupled to the structural sponge component 12 and can be suitably coupled to a surface such as the bottom surface 17 of the horizontal frame member 31.

A thin, releasable element 18 has a length and width substantially equal to those of the second face 15 of the structural sponge component 12 and the adhesive layer 16. The releasable element 18 substantially covers the exposed surface of the adhesive layer 16, thereby facilitating storage, handling and transportation of the sealant backer assembly 10 until it is ready for deployment.

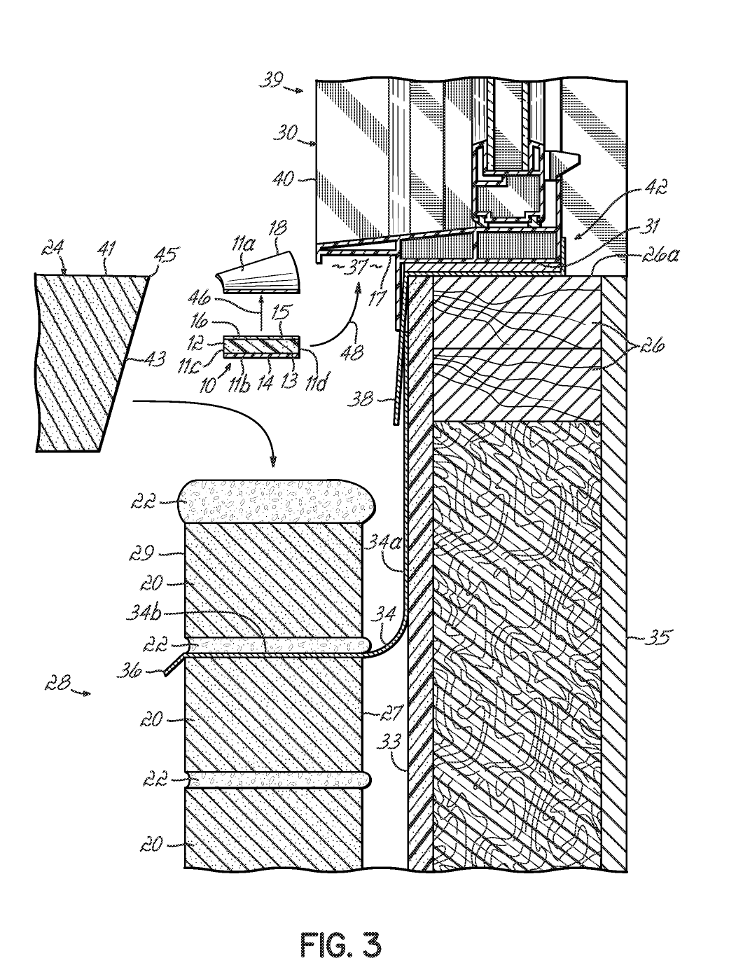

With reference to FIG. 3, an exemplary conventional window frame 30 having an outer surface 40 rests over an inner wall 26 made of wood, and generally covers a window opening 39 communicating the interior and exterior of an architectural structure such as a residence. The inner wall 26 includes an exterior face 33 and an oppositely located interior face 35. An outer wall 28, having masonry elements in the form of bricks 20, includes an exterior face 29 and an interior face 27 that is proximate and faces the exterior face 33 of the inner wall 26. The inner and outer walls 26, 28 are separated by a cavity or gap. In this embodiment, the outer wall 28 includes several rows of bricks 20 and layers of a bonding element in the form of mortar elements 22 positioned between adjacent layers of bricks 20. The window frame 30 includes a horizontal frame member 31 having a bottom surface 17, a portion of which protrudes beyond the plane defined by the exterior face 33 of the inner wall 26. The horizontal frame member 31 is generally designed to lie over a horizontal surface 26a of the inner wall 26.

A relative thin and flexible through-wall flashing member 34 has a vertical portion 34a positioned immediately between the exterior face 33 of the inner wall 26 and the interior face 27 of the outer wall 28 and further includes a generally horizontal portion 34b positioned between adjacent layers of bricks 20 and which extends beyond the exterior face 29 of the outer wall 28, thereby providing a drip surface element 36. The through-wall flashing member 34 is made of a suitable material such as one conventionally known as 40 mil adhesive backed flashing, such that it can provide an impermeable barrier to moisture or water that may penetrate the outer wall 28 and otherwise reach the interior of the architectural structure. Water or moisture that penetrates the outer wall 28 will thus reach the exterior face of the through-wall flashing member 34 and exit along the drip surface element 36.

With continued reference to FIG. 3, a relatively thin, flexible flashing member 38 is conventionally positioned between the horizontal frame member 31 and the horizontal surface 26a and is further partially juxtaposed over the vertical portion 34a of the through-wall flashing member 34. The wrap flashing member 38 is made of an impermeable material suitable to withstand the weight of the window frame 30 resting thereon while preventing the penetration of water or moisture from the exterior and into the interior of the architectural structure. A row of bricks 24 is depicted prior to installation and formation of a window sill under the window frame 30. Each of the bricks 24 includes an upper surface 41, a back surface 43 and an edge 45 at the juncture between the upper surface 41 and the back surface 43.

With reference to FIGS. 3-5, an exemplary formation of a window sill and installation of the sealant backer assembly 10 are depicted. More particularly referring to FIG. 3, a masonry element in the form of a brick 24 is shown ready for deployment and is intended to partially define the window sill. Such deployment includes disposing the brick 24 over a mortar element 22 in the outer wall 28 in a region proximate the window frame 30. The thin, releasable element 18 is removed from the sealant backer assembly 10 as depicted by arrow 46, thereby exposing the adhesive layer 16. The sealant backer assembly 10 is then disposed over the protruding portion of the bottom surface 17 of the horizontal frame member 31 of the window frame 30, as indicated by the arrow 48, and oriented such that the adhesive layer 16 contacts the bottom surface 17.

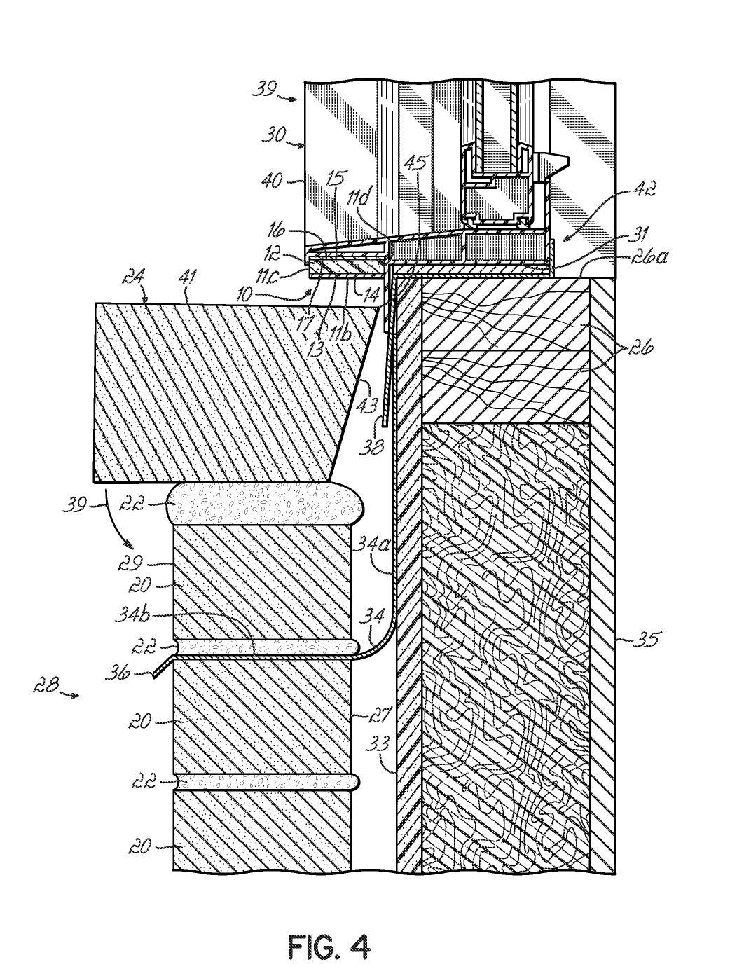

With reference to FIG. 4, a brick 24 is shown having been disposed over the mortar element 22 in the outer wall 28. The sealant backer assembly 10 has been disposed as described above against the bottom surface 17 on the window frame 30. A subsequent step in the formation of the window sill includes reorienting or tilting the brick 24 in the direction depicted by the arrow 39, to thereby allow the upper surface 41 of the sill brick 24 to slope downwardly without substantially deforming the structural sponge component, thereby facilitating drainage of water away from the window frame 30.

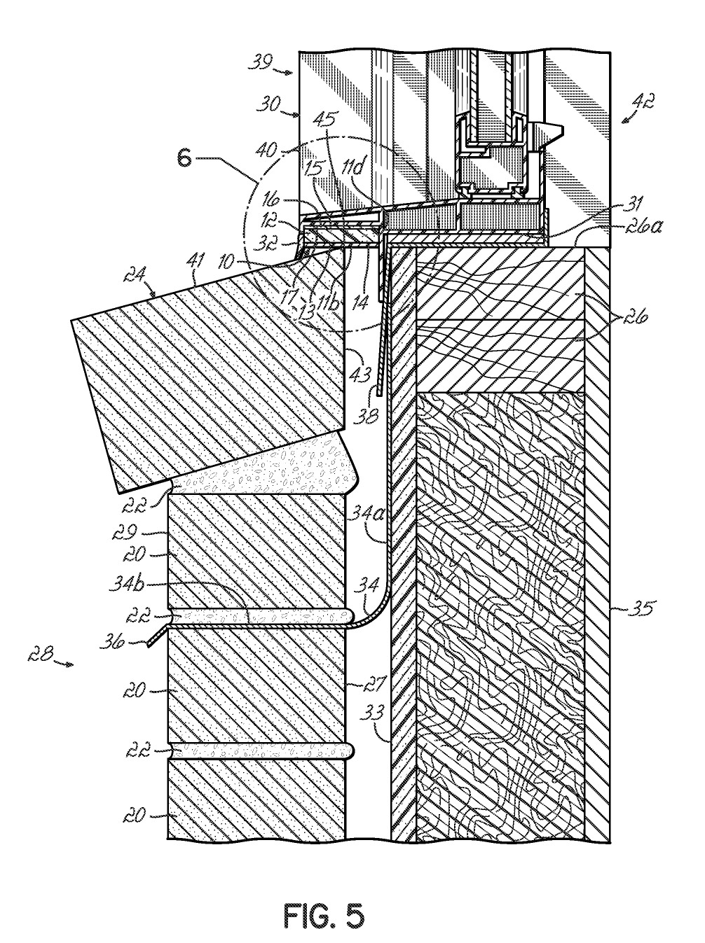

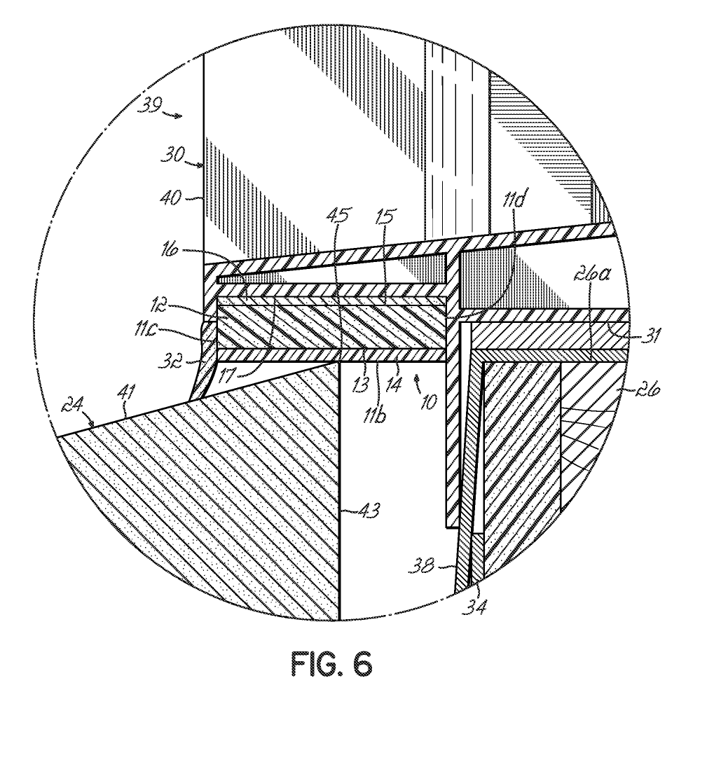

With reference to FIGS. 5-6, the brick 24 is depicted in an exemplary final position showing a downward-sloping angle of the surface 41. Reorienting of the bricks 24 generally includes causing contact to occur between the respective edges 45 of each of the bricks 24 and the bottom face 11b on the hard backing element 14 of the sealant backer assembly 10. A flexible sealant member 32 is applied against the outwardly-facing lateral face 11c of the sealant backer assembly 10 and the upper surface 41 of the brick 24, thereby closing a gap otherwise present, created at the juncture between the irregular surface 41 of the brick 24 and the bottom face 11b of the sealant backer assembly 10. The sealant member 32 is made of a suitable flexible, impermeable and weather-resistant material and may be generally solid even if in flowable form during initial application. The sealant member 32 is further made of a material suitable to bond with the upper surface 41 of the brick 24 or with any other type of masonry element as well as with surfaces of the window frame 30.

With reference to FIG. 6, the sealant member 32 substantially closes the gap between the outer surface 40 of the window frame 30 and the upper surface 41 of the bricks 24. The edge 45 of each of the bricks 24 contacts the bottom face 11b on the hard backing element 14 of the sealant backer assembly 10. Any force applied by the edge 45 against the bottom face 11b on the hard backing element 14 will be distributed by the hard backing element 14 and partially deform the underlying structural sponge component 12. Any individual edge 45 will not compress the sponge component 12 any significant amount, but collectively the edges 45 of the bricks 24 may exert pressure distributed across the sponge component 12 to compress it.

With reference to FIGS. 7-7A, in which like-reference numerals refer to like features in FIGS. 1-6, the sealant backer assembly 10 is shown associated with the formation of an outer masonry wall including masonry elements in the form of stucco elements 37. Unlike the illustrative application of FIGS. 1-6, in the exemplary application of FIGS. 7-7A the stucco elements 37 are placed relatively closer to the inner wall 26 and substantially under the horizontal frame 31 of the window frame 30. In this exemplary embodiment, the main purpose of the sealant backer assembly 10 is to provide a backing surface for reception of a sealant 32 and as a vertical stopping surface for the stucco elements 37. The relationship and description of the sealant 32 with respect to the window frame 30, stucco elements 37 and sealant backer assembly 10 is similar to that described above for the embodiment of FIGS. 3-6.

While the embodiments of FIGS. 3-7A depict a sealant backer assembly 10 associated with masonry elements such as bricks 24 and stucco elements 37 under a window frame 30, persons of ordinary skill in the art will appreciate that, alternatively, sealant backer assembly 10 may be similarly used in association with masonry or non-masonry elements forming a door threshold (not shown) around a door frame (not shown) communicating the exterior and interior of an architectural structure through an opening.

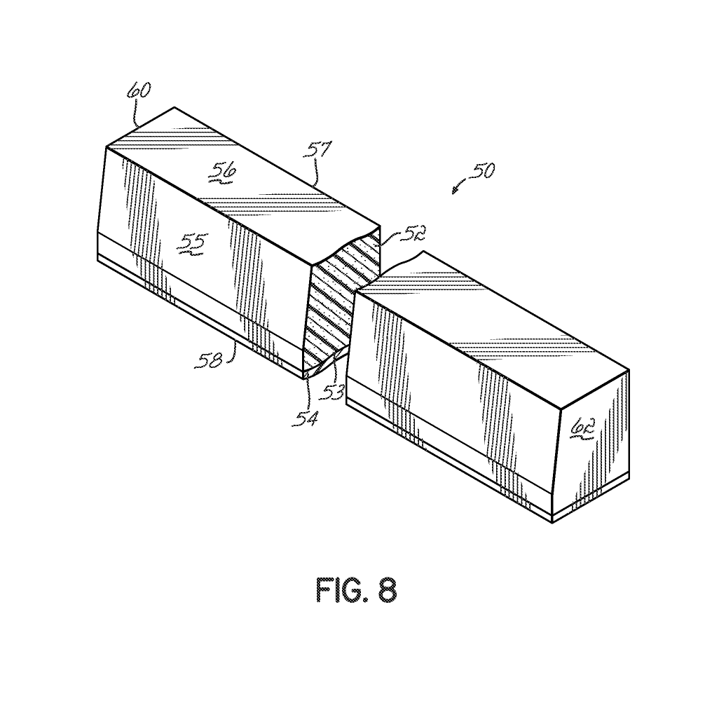

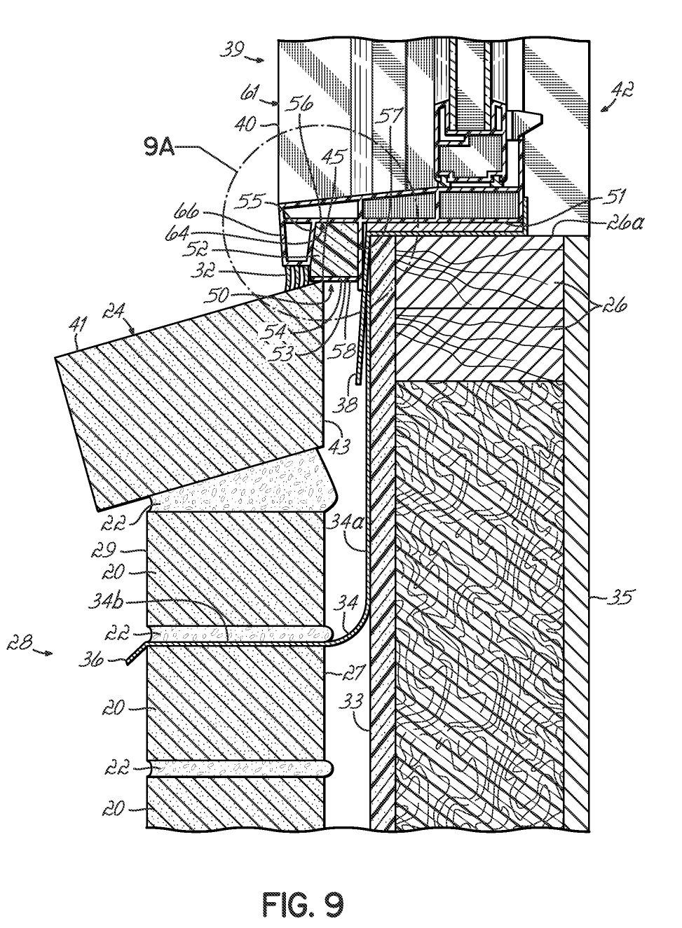

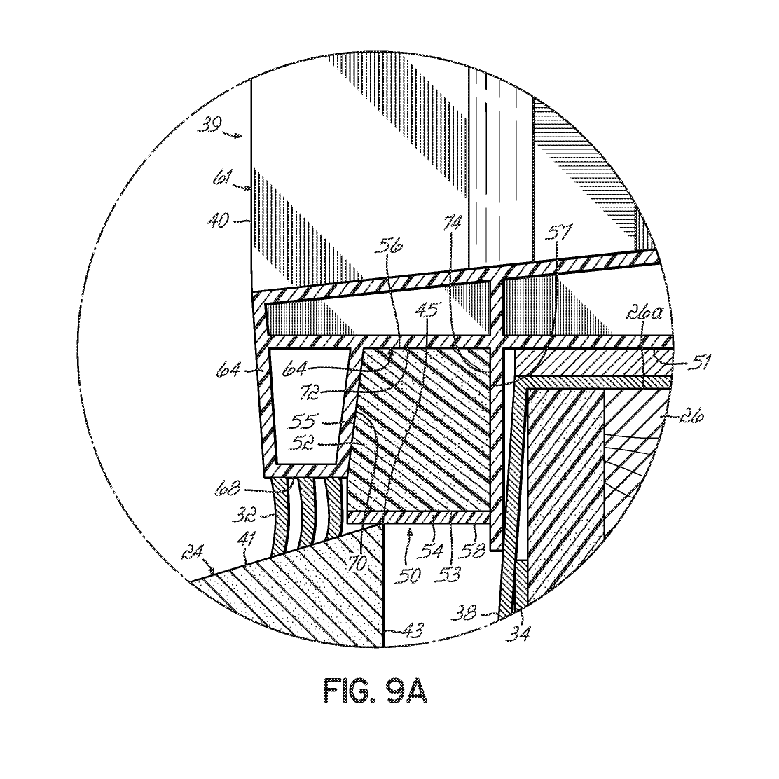

With reference to FIG. 8-9A, in which like reference numerals refer to like features in FIGS. 3-6, an alternative embodiment of a sealant backer assembly 50 having a generally irregular cross-sectional profile, exemplarily approximating a square profile, includes a structural sponge component 52 occupying most of the volume defined by the sealant backer assembly 50, and a rigid hard backing element 54 affixed thereto. The sealant backer assembly 50 is further defined by top and bottom faces 56, 58, front and back faces 55, 57, and end faces 60, 62. The hard backing element 54 is similar to the hard backing element 14 of the sealant backer assembly 10 of FIGS. 1-2, the description and functionality of which may be referred to for an understanding of the hard backing element 54 as well.

The structural sponge component 52 has opposed first and second faces 56, 53 and is made of a suitable material such that the sponge component 52 can withstand a force exerted by an underlying row of masonry elements such as bricks 24 or stucco elements 37 (FIG. 7). The length and width of the structural sponge component 52 is such that it can fit, in a compressed condition, in a channel such as a “J” channel 64 along a horizontal frame member 51 of a window frame 61 or door frame. The structural sponge component 52 is made of a resilient material, such as a material including closed cell blended EPDM neoprene.

During deployment, the exemplary sealant backer assembly 50 is compressed such that the front and back faces 55, 57 are pushed inwardly permitting the sponge component 52 to fit in the channel 64 of the horizontal frame member 51 of the window frame 61. The channel 64 is defined by a leg member 66 having a bottom surface 68 and an inner surface 70, a substantially flat surface 72 along the horizontal frame member 51, and a substantially flat back surface 74. The sealant backer assembly 50 is disposed in the channel 64 such that the hard backing element 54 is left, as shown, outside the channel 64. Alternatively, however, the sealant backer assembly 50 may be disposed in the channel 64 such that the entire backer assembly fits within the channel 64, so long as the sealant backer assembly 50 may be frictionally held in the channel 64, so long as the sealant backer assembly 50 may be frictionally held in the channel 64. After deployment, the sponge component 52 expands such that the front and back faces 55, 57 respectively press against the inner surface 70 of the leg member 66 and the back surface 74 of the channel 64.

With reference to FIGS. 9-9A, other steps in the formation of a masonry sill are similar to those described above for the embodiment of FIGS. 3-6, the description of which may be referred to for an understanding of the embodiment of FIGS. 9-9A as well. Unlike the embodiment of FIGS. 3-6, however, the exemplary embodiment of FIGS. 9-9A depicts the sealant 32 being applied such that it also contacts the bottom surface 68 of the leg member 66 of the channel 64.

While the exemplary embodiment of FIGS. 8-9A depict the sealant backer assembly 50 in association with the formation of a window sill including bricks, persons of ordinary skill in the art will appreciate that the backer assembly 50 may alternatively be used with the formation of sills and outer walls including other masonry elements such as stucco or non-masonry elements. Similarly, the sealant backer assembly 50 may be used in conjunction with the formation of a door threshold around a door frame (not shown).

Advantageously, since the formation of a window sill or door threshold and installation of a sealant backer assembly 10, 50 as shown results in no direct contact between the window frame 30 and masonry elements such as bricks 24, the window frame 30 is less susceptible to relative contraction and expansion of the inner wall with respect to the masonry elements. Any expansion or contraction-related upward, downward or lateral movement of the inner wall with respect to the bricks 24 or the like is absorbed by a corresponding deformation and/or expansion of selected portions of the structural sponge component 12, 52 of the sealant backer assembly 10, 50.

Accordingly, many further embodiments, applications and modifications of the invention will become readily apparent to those of ordinary skill in the art without departing from the scope of the invention which is defined by the claims appended hereto.

What is claimed is:

1. An apparatus for insertion between a masonry element at least partially defining a perimeter of an opening in an architectural structure and a frame surrounding the perimeter and having at least one surface, the apparatus comprising:
a sponge structure adapted to rest against the frame and having at least one surface;
a rigid member affixed to said sponge structure and adapted to rest against the masonry element; and
a coupling element affixed to said sponge structure and adapted to be coupled to a surface of the frame;
wherein said at least one surface of said sponge structure is adapted to adhere to a sealant

2. The apparatus of claim 1 wherein said sponge structure comprises closed cell blended EPDM neoprene.

3. The apparatus of claim 1 wherein said coupling element comprises an adhesive.

4. The apparatus of claim 1 wherein said coupling element comprises a pressure sensitive adhesive.

5. The apparatus of claim 1, wherein said rigid member comprises a plastic resin.

6. The apparatus of claim 1, wherein said rigid member is adhesively bonded to said sponge structure.

7. The apparatus of claim 3, further comprising a thin member releasably coupled to said coupling element.

8. The apparatus of claim 1, wherein said coupling element is adhesively bonded to said sponge structure.

9. An apparatus for insertion between a masonry sill and a frame surrounding the perimeter of a window opening in an architectural structure and having at least one surface, comprising:
a sponge structure adapted to rest against the frame and having at least one surface;
a plastic member coupled to said sponge structure and adapted to rest against the brick sill or threshold; and
an adhesive layer affixed to said sponge structure and adapted to adhere to the at least one surface of the frame;
wherein said at least one surface of said sponge structure is adapted to adhere to a sealant.

10. An apparatus for insertion between a masonry element at least partially defining an opening in an architectural structure and a frame having a channel, comprising:
a compressible sponge structure having at least one surface and adapted to rest against the frame; and
a rigid member affixed to said sponge structure and adapted to rest against the masonry element;
wherein:
said sponge structure is adapted to be friction fit within the channel; and
said at least one surface of said sponge structure is adapted to adhere to a flowable sealant.

11. An architectural installation comprising:
a frame having at least one surface and surrounding a perimeter of an opening of an architectural structure;
a generally vertical inner wall;
a generally vertical outer wall, said wall comprising at least one masonry element; and
an apparatus positioned between said at least one surface and said at least one masonry element;
wherein said apparatus comprises:
at least one surface adapted to adhere to a sealant;
a compressible sponge structure; and
a rigid member affixed to said sponge structure and
adapted to rest against said at least one masonry element;

12. The installation of claim 11 wherein said at least one masonry element comprises a brick.

13. The installation of claim 11 wherein said sponge structure comprises closed cell blended EPDM neoprene.

14. The installation of claim 11 wherein said apparatus further comprises an adhesive layer adapted to adhere to said at least one surface.

15. A method of forming a portion of a wall under a frame surrounding a perimeter of an opening in an architectural structure, the frame having at least one surface, the method comprising:
removing a thin releasable element coupled to an adhesive layer of an apparatus comprising a generally solid sponge structure and a rigid member coupled to the sponge structure and spaced from the adhesive layer;
disposing the apparatus over the at least one surface of the frame such that the adhesive layer contacts the at least one surface on the frame;
disposing at least one masonry element under the frame; and
tilting the at least one masonry element downwardly away from the frame.

16. The method of claim 15 wherein the at least one masonry element comprises bricks.

17. The method of claim 15 further comprising disposing a flowable sealant over at a juncture between the at least one masonry element and the apparatus.

18. A method of forming a portion of a wall under a frame surrounding a perimeter of an opening in an architectural structure, the frame having a channel, the method comprising:
disposing an apparatus having a compressible sponge structure and a rigid member coupled to the sponge structure into the channel;
disposing at least one masonry element under the frame; and
tilting the at least one masonry element downwardly away from the frame.

18. The method of claim 18 wherein the at least one masonry element comprises bricks.

19. The method of claim 18 further comprising disposing a flowable sealant over at a juncture between the at least one masonry element and the apparatus.
